(19) United States
(12) Patent Application Publication
(10) Pub. No.: US 2006/0154603 A1
(43) Pub. Date: Jul. 13, 2006

(54) Method and devices for efficient data transmission link control in mobile multicast communication systems

(76) Inventors: Joachim Sachs, Aachen (DE); Michael Meyer, Aachen (DE); Stefan Wager, Esbo (FI); Jorg Huschke, Aachen (DE); Mikael W Larsson, Sollentuna (SE); Peter Larsson, Solna (SE)

Correspondence Address: ERICSSON INC., 6300 LEGACY DRIVE, M/S EVR C11, PLANO, TX, 75024, US

(21) Appl. No.: 10/527,001

(22) PCT Filed: Sep. 7, 2002
(86) PCT No.: PCT/EP02/10025

§ 371 Date: Oct. 12, 2005

(51) Int. Cl. H04B 7/24

(52) U.S. Cl. 455/39; 370/236; 455/502

(57) ABSTRACT

A method for a data transmission with ARQ protocol using multicast groups such as GSM, GPRS or UMTS in a mobile communication system is described. Data is transmitted in data blocks (PDU) from a transmitter (T) to a plurality of receivers (R1-RM), said data blocks (PDU) being identifiable by an identification (e.g. a sequence number). The receivers (R1-RM) send status indications to the transmitter (T) whether a data block (PDU) is correctly received. The transmitter (T) is adapted to perform retransmissions according to the status indications and has a transmission window comprising the transmission status for the data blocks (PDU) according to their identification. In the method, a synchronization to the transmitter (T) is performed for at least one first of said receivers (Ri), wherein a range of identifications of transmitted data block (PDU) is selected in said synchronization. The transmitter (T) deletes the transmission status for the selected range of identifications from the transmitter window and the first receiver (Ri) stops sending status indications for the data blocks (PDU) corresponding to the selected range of identifications. In addition, a transmitter and a computer program implementing the method are described. As an example the transmitter can be a RNC extending the RLC and MAC-HSPDA protocols standardized by 3GPP for obtaining efficient and reliable point-to-multipoint radio links.

### TECHNICAL FIELD OF THE INVENTION

The present invention relates to a method for a data transmission in a mobile communication system, wherein data is transmitted in data blocks from a transmitter to a plurality of receivers, said data blocks being identifiable by an identification, wherein the receivers send status indications to the transmitter whether a data block is correctly received, and wherein the transmitter is adapted to perform retransmissions according to the status indications. Devices and software programs embodying the invention are also described.

### BACKGROUND OF THE INVENTION

Multicast enables an efficient point-to-multipoint communication if the same information has to be transferred from an information source to multiple receivers. The goal of multicast is to avoid sending multiple copies of information to multiple receivers on a plurality of point-to-point connections but rather send the information on a single multicast connection. A replication of the information is not required unless the end-to-end network paths to the receivers diverge. In this case, the replication is preferably performed at the place where the paths diverge.

Mobile communication systems can be subdivided into radio access networks for providing wireless connections to the user equipment and core networks. Core networks interconnect the radio access networks with each other and further communication systems, e.g. fixed telephony networks or the Internet, and ensure that connections to the users can be established, e.g. by storing an indication of the user position within the communication system and providing bearers for the connection to the users via the radio access networks. Examples of mobile communication systems are GSM (Global System for Mobile Communication), GPRS (General Packet Radio Service) and UMTS (Universal Mobile Telecommunication System) systems.

Data services are anticipated to increase the amount of traffic in the networks drastically and require an efficient data transport. For many voice and data services, the destination will be a user group. Applications of interest for multicast are for example games, information on specific topics like sports, music, distance learning, internet browsing, news services or multiparty communication like video telephony, sending of photos or multi-party messages. For mobile core networks, concepts have been proposed to support multicast, for example on the IP (Internet Protocol) transport layer.

However, for the radio access networks, multicast channels are not available. Therefore, multicast transmission cannot be performed in a radio access network, e.g. between a Radio Network Controller (RNC) in a UMTS radio access network and the base transceiver stations for wireless transmission. Also on the wireless link, a point-to-multipoint radio transmission cannot be performed. Instead the multicast message is duplicated onto multiple point-to-point radio links, which are then transmitted on multiple radio bearers to the receivers of the information. Because particularly radio resources are scarce, this approach is highly inefficient. Multiple radio resources, e.g. in terms of transmission codes, time slots or transmit power, are used. This decreases the capacity in the radio access network, e.g. due to limited resources and increased interference.

Multicast transmission is performed to a subset of all possible receivers. The subset may vary over time. If the subset contains all possible receivers, information is transmitted to all of them. If all receivers leave the multicast destination group, the message is not transmitted. This requires a corresponding addressing scheme for the mobile users and their mapping to a multicast group.

Existing radio broadcast links differ from multicast links because broadcast transmission is based on a point-to-anywhere distribution independent of the receiver group. Information is broadcasted even if not a single receiver is present. Therefore the required radio resources are independent of the receiver group and the system efficiency can be low, especially for a small number of recipients. The transmission is not adapted to the quality of the link to the receivers. Broadcast systems, e.g. digital audio or video broadcast, usually operate on a dedicated, reserved frequency range. In telecommunication systems, however, resources used by multicast or broadcast links are not available for other links. Therefore efficient transmission is required.

In specification 3G TS 25.324 V 5.1.0 (2002-06) of the 3^{rd} Generation Partnership Project, a Broadcast Multicast Control (BMC) protocol is specified for the radio access network. However, the only service supported for multiple recipients is the GSM cell broadcast service (CBS) and the ANSI-41 CBS. Other broadcast and multicast services are not specified.

Current radio links are not suited for point-to-multipoint transmission if a radio link layer for recovering from transmission errors is deployed for radio efficiency. An example is the RLC link layer according to 3GPP specifications. To ensure a high efficiency, radio bearers can be operated in acknowledged mode ensuring data reliability. The acknowledged mode uses an ARQ (Automatic Repeat Request) protocol. Data comprising transmission errors and lost data is retransmitted. This is especially suitable for applications, which do not require strict delay bounds and can tolerate additional delays introduced by retransmissions. A highly efficient transmission configuration in this case is a combination of FEC (Forward error correction) with an ARQ protocol. This avoids overprotection of the information by too much FEC or excessive transmission power. Typically, radio block errors of 1%-20% are a preferable operation range.

European application EP 0 951 198 A2 describes an IP multicast transmission over a wireless ATM network with a scheme for retransmission. To avoid deadlocks from retransmission requests, timers are used. In the transmitter, retransmission requests are discarded after the timer has expired. The receiver stops to request retransmissions after timer expiry.

German publication DE 100 08 148 A1 describes a transmission in which two protocol units are involved, one of them being the RLC protocol. An RLC message can be used to indicate a discard of packets, i.e. packets for which no further transmission attempt will be made. However, the problem of multicast transmissions with a plurality of receivers is not addressed.

European application EP 1 178 624 A2 describes a retransmission control method for a multicast information distribution service. In the method, information is distributed to a plurality of terminals and retransmissions are requested at a timing determined by the terminals.

U.S. Pat. No. 5,905,871 relates to a further multicasting method for transmitting data segments over an established global multicast-tree using acknowledgements for the data segments.

Although link layer ARQ is a very efficient technique to save radio resources, currently, no link layer ARQ for point to multipoint radio transmission exists, which allows an effective use of the radio resources and avoids malfunctions of the protocol.

### SUMMARY AND DESCRIPTION OF THE INVENTION

It is an object of the present invention to obviate the above disadvantages and provide a method and devices for a reliable point-to-multipoint data transmission in a mobile communication system, which allows an effective use of radio resources and avoids malfunctions of the protocol. It is a further object, to allow a configuration of the link reliability.

According to the invention, the method described in claim 1 is performed. Furthermore, the invention is embodied in a transmitter as described in claim 13 and a computer program as described in claim 14. Advantageous embodiments are described in the further claims.

The proposed method concerns a data transmission in a mobile communication system. Data is transmitted in data blocks from a transmitter to a plurality of receivers, i.e. the data blocks are sent in a multicast transmission to all receivers in the plurality without replication. Typically, all receivers are located in the same cell of a cellular communication system. To allow a retransmission in case of erroneous, i.e. missing or incorrectly received, data blocks, the data blocks are identifiable by an identification, e.g. a sequence number. The receivers are adapted to determine whether a data block is erroneous and to send status indications to the transmitter whether a data block is correctly received. The status indications can identify either erroneous or correctly received data blocks or both. According to the status indications, the transmitter performs retransmissions of erroneous data blocks and, optionally, data blocks for which status indications are missing.

In order to track the status of the data blocks, the transmitter is provided with a transmission window comprising the transmission status for the data blocks according to their identification. The transmission status is updated according to the status indications of the receivers. Unacknowledged data blocks identified in the transmission window remain stored in the transmitter to allow their retransmission. Generally, a maximum size of the transmission window exists due to limited memory space and delay requirements. Also, ambiguities in the data block identifications must be avoided if those are attributed in a recurring scheme. In case of a high number of erroneous transmissions, the protocol may therefore malfunction, especially if the maximum window size cannot accommodate all transmission status indications of erroneous data blocks.

According to the proposed method, a synchronization is therefore performed between the transmitter and at least one first of said receivers. In many cases it will be performed with all receivers, i.e. without relating to a particular receiver or subgroup of the receivers. In the synchronization, a range of identifications of transmitted data blocks is selected. The transmitter deletes the status indications of the selected identifications from the transmitter window. As a result, the edges of the transmitter window can be moved, especially to allow the storing of status indications for further data blocks if the window size is limited. The first receiver considers the data block as not recoverable and stops sending status indications for the data blocks corresponding at least to the selected range of identifications.

Typically, different data blocks will be erroneous or missing for each receiver. Apart from the selected range, differences are therefore possible between the data blocks detected as erroneous or missing by the first receiver and those data blocks indicated as erroneous or unacknowledged in the transmitter window. Further reasons for such differences may for example be round-trip times of messages or lost messages between transmitter and receiver.

The proposed method allows a reliable point-to-multipoint data transmission in a mobile communication system and an effective use of radio resources. Advantageously, the reliability can be configured in the proposed method, e.g. by controlling the number of synchronizations per interval of time or per predefined number of transmitted or retransmitted data blocks. A malfunctioning of the transmission is avoided, especially in the case of a high fraction of erroneous transmissions.

The method is especially suited if a single or few receivers in the multicast transmission suffer a high fraction of data block loss. The method can prevent that the protocols in other receivers are negatively affected by those receivers with bad reception conditions and avoids in this way a decrease of the overall transmission efficiency. The method can be used for different types of communication systems, e.g. for a communication system according to 3GPP specifications where the method could be implemented on the RLC layer or for a WLAN system where it is suitable for implementation on the DLC layer. Other methods avoiding transmission errors can be used in addition to improve the transmission performance, especially methods adding redundant information to data blocks or packets for error detection and correction, e.g. FEC.

In a preferable embodiment of the proposed method, the synchronization is performed by a synchronization message between the transmitter and the first receiver. A synchronization message from the transmitter can address either all receivers in the multicast group or a single receiver or a subgroup of the receivers. Preferably, both a common group address and individual receiver addresses are defined for this purpose. If the receivers use receiver windows for tracking the status of received data blocks, the message can for example a command to move the edges of the receiver window, i.e. the synchronization is performed in this case by a message to move the window. As transmitter and receiver windows are preferably aligned, this message can be sent to all receivers.

A synchronization message can be triggered by a plurality of different events. For example, the message can be sent when a timer or counter expires, e.g. when a data block or a data packet of a higher layer composed of the data blocks has been stored in a memory for a predefined time or when a preset number of transmissions or retransmissions of a data block has been performed. A threshold value for used memory is also possible, e.g. when the transmission window has reached a predefined size. Furthermore, a data field in a protocol data unit of a higher layer can be evaluated to trigger the message, e.g. a time stamp in an SDU or the identity of the used protocol. For example, the synchronization can be performed differently if the data blocks correspond to UDP or TCP data units on a higher protocol layer. The number of positive, negative or missing acknowledgements for a data block may trigger a synchronization message. Finally, it is often advantageous to combine different of these triggers or to use them simultaneously.

A receiver preferably sends an acknowledgement for the synchronization message and the status indications corresponding to the selected range of identifications are deleted from the transmitter window only after the acknowledgement is received. Else the transmission protocol may not function properly. Especially, if the synchronization message is sent to two or more receivers either the synchronization message or the acknowledgement may be lost for a receiver. It is often preferable that the transmission window is adapted if the transmitter has received all acknowledgements. In other cases, especially if the transmission may stall, it is preferable to adapt the transmission window after a predefined fraction of the acknowledgements is received. It is also possible that the synchronization message is retransmitted in case of missing acknowledgements and the transmission window is moved if a predefined fraction of acknowledgements for the retransmitted synchronization message is received. Such fractions can for example be defined as a percentage of the receiver group or as a total number of receivers, e.g. one receiver, two receivers, all receivers or the total number of receivers in the multicast group minus one. Different fractions may be suitable for optimum performance under different transmission conditions. It is also possible to use a timer or counter in addition to trigger the synchronization if the fraction is not reached in a predefined interval or to trigger a retransmission of the synchronization message. If the transmission window can be moved after a predefined fraction of acknowledgements is received, preferably a further synchronization is performed with those receivers for which acknowledgements are missing, or said receivers may be dropped from the multicast group. This can avoid protocol malfunctions, e.g. due to ambiguities in the case of recurring sequence numbers.

A synchronization message can also be sent by a receiver, e.g. if a protocol malfunction is detected in the receiver. In this case the transmitter can send variables for the synchronization of the receiver with or after an acknowledgement of the synchronization message.

Alternatively or in addition to synchronization messages, synchronization events can be defined for the transmitter and the receivers, e.g. the first receiver. In this case, the synchronization is performed at the defined synchronization events by the receiver and by the transmitter autonomously while the definition of the events ensures the synchrony. Suitable synchronization events are for example predefined time intervals or block numbers. E.g., the receiver and the transmitter can move the transmission and the reception window by n data blocks every m milliseconds or after a data block with a sequence number larger than x is transmitted where n, m and x are numerical values. The values and conditions for the events can be predefined default parameters or they can be transmitted during configuration and reconfigurations of the transmission.

Preferably, the identifications of the data blocks are sequence numbers and the sequence numbers identify the data blocks in a modulo numbering scheme, i.e. after a period of time the same sequence number is used to identify a different data block. The modulo numbering scheme allows a fixed size of the sequence numbers, e.g. in a header field of the data blocks. The proposed method can be used to avoid ambiguities by deleting the status indications from the transmission window before the reattribution of the sequence numbers to new data blocks. In this way, the reliability of the transmission is ensured.

Generally, each receiver has a receiver window comprising identifications of data blocks, which are not correctly received. The receiver window has a lower and an upper edge corresponding to the data block identifications, e.g. sequence numbers, limiting the receiver window. Preferably, one or both edges of the receiver window can be moved in the synchronization, e.g. according to the synchronization message or to predefined conditions when a defined event is reached.

An advantageous transmission window comprises a cumulative transmission status for the data block identifications. The cumulative status is determined from the individual status indications sent by the receivers, for example by a logical AND operation in case of acknowledgements or by an OR operation in case of negative acknowledgements. This simplifies the handling of the retransmissions. In case of sufficient memory and processing capacity of the transmitter, storing of an individual status for the receivers can improve the transmission performance.

Preferably, the status indications from the receivers comprise cumulative acknowledgements for groups of correctly received data blocks. For example, acknowledgement of data block n acknowledges the previous data blocks in the transmission window as correctly received, i.e. those blocks with a sequence number smaller n. In this way, the size and number of acknowledgements can be reduced. Especially in case of low error rates, negative acknowledgements for erroneous data packets are preferably sent individually to reduce delays.

To reduce the number of status transmissions, especially in case of a high number of receivers, the receivers preferably indicate the transmission status in a status message, which is requested by the transmitter with a poll message. This ensures also that the latest information from the receivers is available when the transmitter determines which data blocks need to be retransmitted. While the status message is preferably sent immediately in reply to a poll message addressed to a single receiver, random delays are preferable in reply to poll messages addressed to a plurality of receivers. The receivers send the status message in reply to the poll message with a random delay, which is preferably small compared to the intervals between the poll messages. The delay avoids collisions of messages, especially if a random access channel is used for the status messages and reduces the burstiness of the traffic. Triggers for a poll message can be those triggers mentioned above for a synchronization message although the threshold values of poll timers or counters will generally be different.

The transmitter stores at least the number and preferably the identifications of the receivers to determine whether status messages or acknowledgements are missing and to trigger according retransmissions in case of loss. Preferably, a memory in the transmitter comprises an address list of receivers. Tracking of the receiver number can be used to stop the transmission if all receivers leave the multicast group. When a receiver joins or leaves the data transmission, the transmitter preferably receives an according notification, either from another protocol entity or by in-band or out-band signaling from the receiver or from a node in the communication system. The expected number and/or the status of acknowledgements for the data blocks can be adjusted in this way to the changed number of receivers.

If a receiver joins the data transmission, a synchronization message can identify a valid selected range of identifications. In this case, the receiver can immediately process received data blocks. The message can be a command to move the receiver window to a particular value, e.g. to set the lower edge of the receiver window to the lowest missing or negatively acknowledged data block or to the next data block scheduled for first transmission or to the next first data block corresponding to a packet of a higher protocol layer. When joining a transmission, the receiver can alternatively synchronize itself without a message to the multicast transmission, e.g. by determining the edges of the receiver window according to the lowest and/or highest data block number detected in an interval of time or defined number of received data blocks.

A preferable transmitter for a mobile communication system is adapted to transmit data blocks to a plurality of receivers in a multicast transmission. The data blocks are identifiable by an identification. The transmitter is furthermore adapted to receive status indications from the receivers whether a data block was correctly transmitted. The transmitter has corresponding transmission and reception units, for example a transceiver, which is connected to a processing system for processing according messages and data blocks. The processing system comprises also a memory in which a transmission window is stored. The transmission window comprises the transmission status for the data blocks according to their identification.

The transmitter is adapted to perform a synchronization with at least one first of said receivers. In the synchronization, a range of identifications of transmitted data blocks is selected and the transmitter deletes the status indications for the selected range of identifications from the transmitter window. The transmitter is for example a radio base station, a radio network controller or a user equipment, e.g. a mobile phone or a portable computer with a wireless transmission unit.

An advantageous software program unit is loadable into a processing unit of a transmitter for a mobile communication system. The program unit can be part of a software packet for the transmitter including further software components, e.g. a processing system. The transmitter is adapted to transmit data blocks to a plurality of receivers, said data blocks being identifiable by an identification, and to receive status indications from the receivers whether a data block is correctly transmitted. The transmitter is provided with a transmission window comprising the transmission status for the data blocks according to their identification. The transmission window as well as routines for the handling of status data in the transmission window may be implemented also by the program unit. The program unit comprises code for performing the steps of initiating a synchronization to at least one first of said receivers and selecting a range of identifications of transmitted data blocks in said synchronization, and deleting the status indications for the selected range of identifications from the transmitter window when the program unit is executed in the processing unit.

The program unit can for example be stored on a data carrier or it can be directly loadable into a transmitter e.g. as a sequence of signals. The program unit and the transmitter can be adapted to any embodiments of the described method.

The foregoing and other objects, features and advantages of the present invention will become more apparent in the following detailed description of preferred embodiments as illustrated in the accompanying drawings.

### BRIEF DESCRIPTION OF THE DRAWINGS

FIG. 1 shows data transmission and signaling in a point-to-multipoint transmission according to the invention.

FIG. 2 shows the signaling for the moving of a transmission window, wherein feedback from the receivers is combined.

FIG. 3 shows a receiver initiated reset in a point-to-multipoint transmission.

FIG. 4 shows a transmitter initiated partial reset in a point-to-multipoint transmission.

FIG. 5 shows a transmitter initiated total reset in a point-to-multipoint transmission

FIG. 6 shows a transmitter for an ARQ protocol.

### DETAILED DESCRIPTION OF PREFERRED EMBODIMENTS OF THE INVENTION

In the following description the proposed method is described in the context of a WCDMA (Wideband Code Division Multiple Access) system as it is used in UMTS. However, the method can be used in any system in which link layer error recovery is applied, e.g. for ad-hoc or WLAN networks. It should also be noted that in a practical implementation often a message sequence will be used instead of single messages as depicted in the figures.

The term multicast radio link in this description refers to the physical radio link or physical channel of the multicast radio bearer while multicast shared channel and multicast access channel refer to transport channels transmitted via physical channels. A multicast radio bearer comprises the link layer (e.g. with the protocols Medium Access Control (MAC) and Radio Link Control (RLC)) transmitted over a physical layer.

In case of a downlink transmission, data is transmitted to a multicast group consisting of several user equipments as receivers, all located in the same cell of a cellular mobile system. The transmitter can be a base transceiver station, also denoted as node B in a UMTS system, or an RNC, depending on the implementation of the protocols in the different nodes. In most cases, the data for transmission will be received via the core network of the communication system. The downlink transmission can be performed via a multicast shared channel with a multicast access channel as uplink. The receivers of the multicast transmission may also have in parallel individual point-to-point radio links with the communication system. An addressing scheme for the receivers allows the tracking of their status by the transmitter and their identification within the multicast group.

The multicast group throughout this description comprises the receivers to which the transmission is performed over the same radio link. The total number of receivers of the multicast transmission, e.g. on the application layer or transport layer of the communication system, may be larger than this multicast group in the cell and contain users of multiple cells.

Most multicast services are of type best effort, background or streaming, and have loose requirements in terms of transfer delay. Multicast services can have a range of requirements on the transmission link, which can be negotiated for a UMTS bearer or other radio bearers. The radio bearer can be selected to support requirements, e.g. for transmission delay, data rate or reliability. Unless a radio bearer has stringent requirements on transmission delay, it can be realized resource efficiently if a joint FEC and ARQ scheme is used to provide a reliable data transmission.

Link layer ARQ protocols in the state of the art, e.g. RLC and MAC-HSDPA (High Speed Downlink Packet Access) according to 3GPP specifications, operate as point-to-point protocols. In an ARQ protocol, data is generally transmitted in data blocks, which are numbered, e.g. by a sequence number in a header of the data block, or identifiable in another way, e.g. according to the time of transmission. The transmitter sends the data blocks and stores according identifications, e.g. sequence numbers, within a transmission window. Typically, the receiver accepts data blocks only within a receiver window and updates the status of data blocks identified in the receiver window according to the received blocks.

The receiver has a processing system adapted to identify data blocks which are not correctly received, e.g. using a check sum included in the data blocks, or which are totally lost, e.g. from a missing sequence number when a numbering scheme with consecutive block numbers is used. The receiver indicates to the transmitter either whether a block was correctly received (ACK) or which blocks are not correctly received (NACK) or both. The corresponding messages are denoted status reports. An ACK (acknowledgment) or NACK (not ACK) can be generated for each received data block or in a cumulative for a group of data blocks.

The transmission window is adjusted according to the status reports. The receiver window and transmission window need to be aligned in order to avoid malfunctioning of the protocol although they are not necessarily identical. Malfunctions can especially occur if a recurring or modulo numbering scheme is used for the sequence numbers, which allows for a defined size of the sequence numbers. If the modulo numbering revolves while data blocks are still waiting for retransmission, ambiguities in the block identities arise.

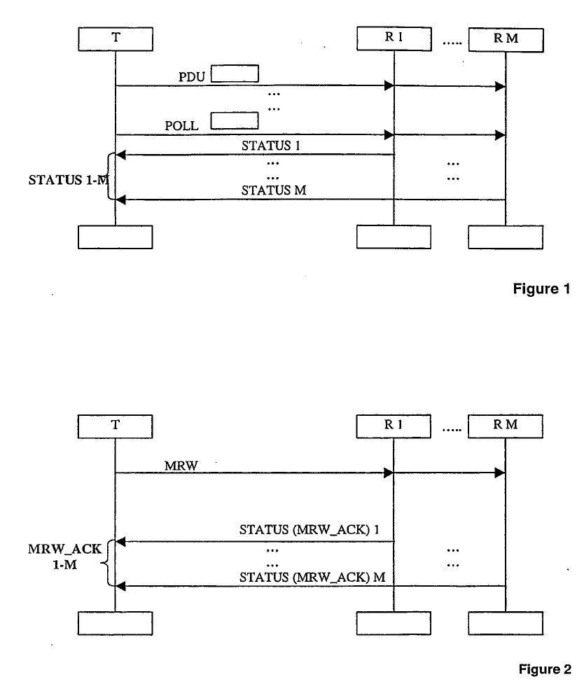

FIG. 1 shows an example of a PTM (point-to-multipoint) ARQ transmission on the link layer. Data is multicast in data blocks from a transmitter T to M receivers R1-RM in data blocks PDU. For reasons of simplicity, only one of said data blocks is indicated. The term receiver denotes the receiver of the data blocks, e.g. RLC AM (Acknowledged Mode) data, although the receivers are also sending, especially messages STATUS. M messages STATUS 1-STATUS M are received and combined at the transmitter. Correspondingly, the transmitter is preferably provided with a memory and a processing system adapted to identify the protocol states of the individual receivers. Retransmissions of erroneous data blocks are performed according to the combined status indications. Alternatively, the transmitter can track the origin of the status messages. It is possible to perform the retransmissions either on the bearer for the multicast transmission or on dedicated links to the respective receivers.

To provide a reliable multicast ARQ link layer protocol, e.g. a multicast RLC ARQ protocol, a synchronization of the M+1 link layer states of the receivers and the transmitter is performed in addition to the necessary retransmissions. In one option, the status in the transmission window is only updated for blocks for which a message STATUS has been received from all receivers R1-RM. A request of the messages STATUS by status polling is beneficial since it synchronizes the status reports from the plurality of receivers. This is indicated by the message POLL. Typically, the poll message is an ordinary data block wherein a poll bit is set in the header. For large receiver groups, a random delay before the transmission of a status report is useful to reduce collisions and the bursty traffic of the reverse link when replying to a poll message POLL.

The status for the data blocks in the receiver window is updated as in an ARQ protocol in the state of the art. In the transmitter window, cumulative status indications are used which are determined by a logical operation from the individual status messages from the receivers. Different options exist for the data block status in the transmitter window. In one option, the status is set for a transmitted data block to:
Acknowledged, if an ACK for this data block has been received from all receivers R1-RM.
Not-acknowledged, if only ACKs have been received but no NACK and at least an ACK from one receiver is missing.
Missing, if at least one NACK has been received from a receiver.

In this option, a retransmission can be triggered immediately for a data block with the status Missing, while for the status Not-acknowledged a waiting time, e.g. supervised by a timer, can be used to allow the reception of outstanding ACK or NACK messages. In another option, the states Not-acknowledged and Missing can be combined and handled in the same way, e.g. in both cases a retransmission can be triggered immediately.

The transmitter tracks the number of receivers as well as their individual status. For a PTM ARQ protocol, the transmission window size is preferably less or equal to half the maximum range of ARQ sequence numbers minus one. This avoids an ambiguity of retransmissions, especially if triggered by different receivers. In some ARQ protocols (e.g. RLC) the reliability or persistence of the ARQ scheme can be configured. This can, e.g., be done according to the IP multicast protocol identifier on the transport layer, which indicates for example a reliable multicast transmission, by mapping the identifier to the ARQ layer.

One or more of the receivers R1-RM may not have received a data block when it is necessary to move the transmitter window to avoid a stalling of the transmission. This can for example be the case for receivers under bad reception conditions with a high number of transmission errors, e.g. in a tunnel. In this case a forced synchronization of receivers is required, i.e. the transmission of the missing data blocks is stopped, leading to a semi-reliable ARQ transmission.

Generally, the data blocks will be assembled to larger data packets processed in a higher protocol layer of the receiver. For example, in the RLC protocol, several data blocks can be assembled to an SDU (Service data unit). The RLC specification defines an SDU discard function in the receiver for discarding an SDU, which is not completely received. The discard function can be triggered by a timer expiry for the SDU or if a data block containing at least a part of the SDU has been retransmitted for a predefined number of times. This allows to limit the delay for a certain data packet and defines a persistence of the ARQ algorithm.

As depicted in FIG. 2, a forced synchronization can be performed in an ARQ PTM protocol by sending a message MRW from the transmitter to all or some receivers. Message MRW initiates a moving of the receiver window. The message indicates which data blocks are to be discarded by the receiver and thus to which sequence number the receiver window has to be advanced. It is possible to select the sequence number in correspondence to packets of a higher protocol layer, e.g. SDUs, to allow the total reception or discard of such packets.

To the message MRW, the receivers reply with an acknowledgement MRW_ACK, which can be included in message STATUS as indicated in FIG. 2. The synchronization is terminated if acknowledgments MRW_ACK have been received from all receivers R1-RM. If not all acknowledgements MRW_ACK are received within a predefined time, generally supervised with a timer, the message MRW is repeated. Otherwise, the protocol in receivers, which did not receive the message MRW, may malfunction and eventually misinterpret received data when the same sequence numbers are reused for later data blocks.

By the message MRW a synchronization of the receivers is ensured because the lower edges of the receiver windows are aligned. To avoid an inefficient protocol if only one or few receivers have bad reception conditions, the synchronization can already be performed when a certain percentage of the receivers has acknowledged the data blocks in a region of the transmitter window adjacent to the lower edge or alternatively all data blocks corresponding to a data packet in a higher layer. The message MRW may alternatively or in addition be triggered by a timer or by a counter value corresponding to a number of retransmissions.

In case that an error is detected when performing the PTM transmissions, a reset can be initiated. A reset procedure also allows a resynchronization of the receivers and the transmitter. The reset may either be initiated by the transmitter T or by one of the receivers Ri.

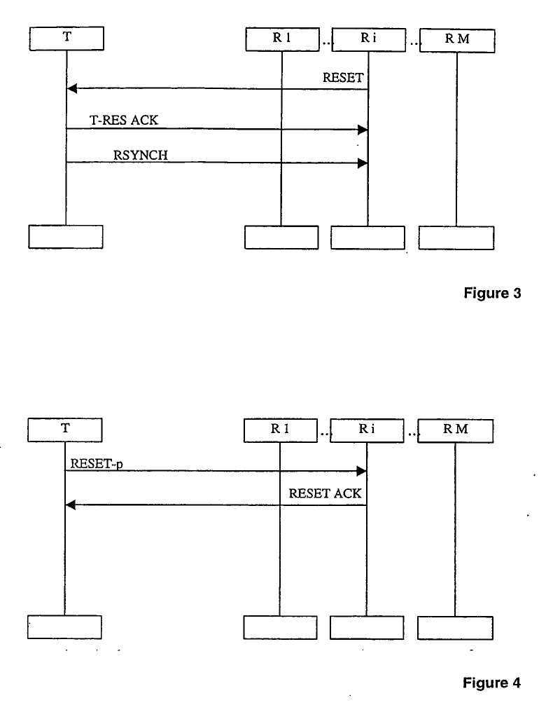

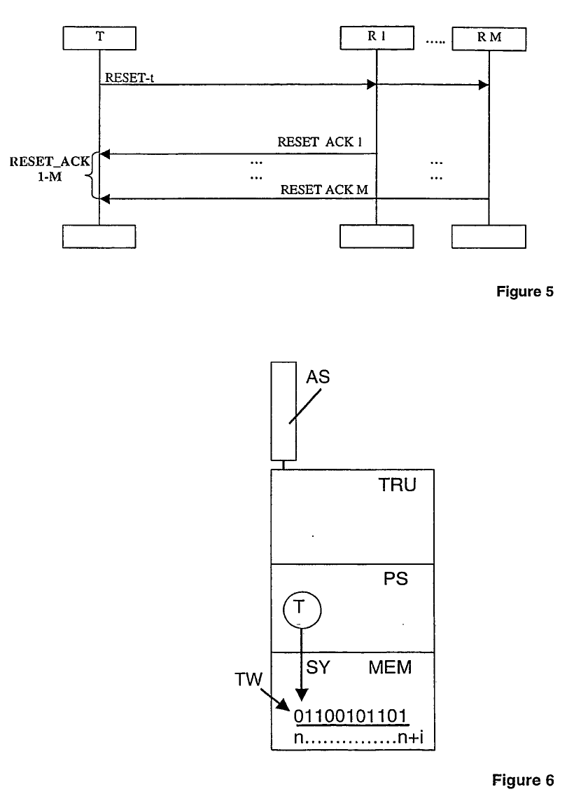

In a receiver-initiated reset, a message RESET is sent by receiver Ri as shown in FIG. 3. Accordingly, receiver Ri can also release its buffers, e.g. delete all stored data blocks, and reset protocol variables. In contrast to a point-to-point protocol in the state of the art, the transmitter does not re-initialize its protocol state when receiving message RESET. The transmitter acknowledges the message RESET with a message T-RES ACK. In addition, the transmitter resynchronizes the receiver Ri, e.g. informs receiver Ri of the current lower edge of the transmitter and receiver window. This can be done either within the message T-RES ACK or in a separate message RSYNCH as depicted in FIG. 3. If only the receiver window needs to be aligned, also the message MRW as described with respect to FIG. 2 can be used. If the transmitter is not able to resynchronize receiver, the receiver is preferably dropped from the PTM ARQ connection. Alternatively, a transmitter-initiated reset as shown in FIG. 5 can be performed.

If no ciphering used on the connection, the receiver can also perform a local reset without signaling to the transmitter. In case of ciphering, this is generally not possible because variables for the deciphering need to be resynchronized. In a local reset, the receiver releases its buffers and resets the protocol variables after detecting a protocol error. Upon receiving the next data block PDU from the transmitter, the receiver can set the lower edge of the receiver window to the sequence number of said data block. Other receiver variables like the upper edge of the receiver window or the next expected sequence number can also be determined from this sequence number and configured variables, e.g. a configured window size. If the data block used for defining the variables is a retransmission, a further synchronization and unnecessary retransmissions of data blocks already acknowledged by all other receivers may be triggered. Therefore, the receiver preferably performs a further reset of the variables corresponding to the receiver window if missing sequence numbers are detected after the first local reset, e.g. to the highest sequence number received within the first round trip time of the protocol after the first local reset. Data blocks received afterwards outside the receiver window are discarded.

FIGS. 4 and 5 show different options for a transmitter-initiated reset. If the protocol error triggering the reset procedure happens in the transmitter and the transmitter is capable of identifying which receivers caused the protocol error, it can initiate a partial reset for those receivers. In a partial reset (FIG. 4), the transmitter keeps its own protocol state and resynchronizes the receivers Ri, which caused the error by a message RESET-p. The receivers Ri reset their protocol states and synchronize to the transmitter according to the message RESET-p. If only the receiver window needs to be adapted, a message MRW to move the receiver window can be used instead of message RESET-p. The receiver Ri replies to the messages with an acknowledgement RESET ACK or MRW_ACK, respectively.

If the transmitter, as in FIG. 5, is not able to detect which receivers caused the protocol error, or if the transmitter itself caused the protocol error, a total reset of the PTM ARQ connection can be performed. The transmitter resets its protocol state and sends a message RESET-t to all receivers R1-RM. The receivers reply to the message with corresponding acknowledgements RESET ACK 1-RESET ACK M. The new protocol variables can either be sent in message RESET-t or in a later message after receiving the acknowledgements. Only if an acknowledgement is received from all receivers the reset procedure is successful. Else the connection can either be totally released or those transmitters can be dropped from the connection from which no acknowledgement is received.

In many cases, a ciphering is not necessary on the PTM ARQ connection because of the shared nature of the content. Ciphering can however be required for services for a limited user group, e.g. for reasons of confidentiality or for services subject to charging. If the ciphering depends on a varying parameter, an according synchronization is also required. For example, according to 3GPP specifications, the required parameters can be a hyper-frame number for radio bearers that are mapped onto RLC in acknowledged mode, a hyper-frame number for radio bearers that are mapped onto RLC in unacknowledged mode, a radio bearer identification and a ciphering key.

If ciphering is used on a PTM ARQ connection, preferably a common ciphering key is used for the multicast group. The synchronization of the time varying parameters, e.g. the hyper-frame numbers, between user equipment and RNC sets requirements on the protocol reset and data block discard procedures. If only downlink traffic needs to be ciphered, the transmitter, e.g. the RNC, informs the receivers at each reset. Also data block discarding is preferably handled by explicit signaling.

In reliable multicast transmissions all receivers start with the same initial protocol state. When an additional receiver joins a PTM ARQ connection or a receiver leaves, the protocol states of transmitter and receiver have to be adapted. This is not required in if unreliable transmission without retransmission is performed. A preferable combination comprises an unreliable multicast stream on the transport layer, which may both be transmitted to wireless and fixed receivers, with reliable link layer transmission for radio resource efficiency.

If an additional receiver joins an ongoing multicast session, i.e. a PTM ARQ connection, the additional receiver configures itself to the connection. Else excessive delays may occur. For example, a receiver may have a receiver window size of 1000 data blocks and initializes the window for sequence numbers from 0-1000, while the ongoing connection is presently using a sequence number range of 1500-2500. Then the additional receiver will be unable to join the transmission and discard all received data blocks until the connection reaches again the sequence number range 0-1000. Furthermore, STATUS messages from the additional receiver will typically differ significantly from STATUS messages of the other receivers. Therefore, the transmitter may not be able to advance the transmission window, leading to a stall condition. If, in contrast, the additional receiver initializes its lower receiver window edge to 1500 and/or the upper window edge to 2500 when joining the connection, it is immediately able to receive data.

There are different options how to synchronize a joining receiver. When setting up the receiver, e.g. via radio resource control signaling according to 3GPP specifications, the required parameters like the sequence number of one or both receiver window edges can be included in the transmitted parameter set. Alternatively, a dedicated message can be used for the synchronization of a joining receiver. Also a message for moving the receiver window or a local reset without signaling as described above may be used for synchronization.

When an additional receiver joins the PTM ARQ connection, the transmitter is informed about the additional receiver. The additional receiver is then included into the list of receivers for which the transmitter checks and synchronizes the protocol states. For a 3GPP receiver, the information can be provided by the radio resource control protocol (RRC) or by the broadcast multicast control protocol (BMC).

When a receiver leaves the PTM ARQ connection, the transmitter removes it from the receiver list. A multicast RLC transmitter can obtain this information from the leaving receiver, e.g. via RRC or BMC. If all receivers left or are dropped the transmitter preferably stops sending data to save radio resources. When the transmitter receives a corresponding signal it can stop the operation on the connection. Data can, however, still be stored in the transmission buffer to allow a connection to new receivers with low delay. When the transmission buffer reaches its limit, data can be discarded in this case.

In a multicast transmission, the status messages can also be optimized. Status messages can contain different types of information. A cumulative acknowledgement (ACK) indicates a sequence number up to which all data blocks have been correctly received. An individual ACK identifies a particular data block, which has been correctly received. A NACK identifies a particular data block, which was not correctly received. For a cumulative retransmission scheme of a PTM ARQ, status messages preferably comprise NACKs or cumulative ACKs so that only a small number of individual ACKs is required.

Status messages can for example be triggered by receiver events, e.g. if a timer or counter reaches a threshold, or by a request from the transmitter, i.e. by polling. If status messages are combined at the transmitter in a time interval, it is useful to synchronize them, to have the latest state of information for all receivers, optionally with a small random delay to avoid collisions. Therefore it is proposed to trigger status messages preferably by polling.

FIG. 6 shows a transmitter for a mobile communication system, which is adapted to transmit data blocks to a plurality of receivers in a multicast transmission. The transmitter has a transmission and reception unit TRU, for example a transceiver, which is connected to an antenna system AS and a processing system PS for processing messages and data blocks. The data blocks are identifiable by an identification indicated as sequence numbers n . . . n+i in FIG. 6. The transmitter is furthermore adapted to receive status indications from the receivers via antenna system AS whether a data block was correctly transmitted. The processing system PS is connected to a memory MEM in which a transmission window TW is stored. The transmission window TW comprises the transmission status for the data blocks according to their identification, i.e. bits set to 0 or 1 at the memory positions indicate whether the data block corresponding to the position is acknowledged or not. It is also possible to use a matrix as transmission window, in which the rows correspond to the different receivers and the matrix columns correspond to the data block identifications.

If a negative acknowledgement is received for a data block, the processing system PS can initiate a retransmission by transmission and reception unit TRU. A timer T in the processing system triggers that the transmission window TW is moved to a new range of identifications n+j . . . n+j′ at a predefined time using a synchronization signal SY. Synchronization signal SY can also trigger a synchronization message to the receivers.

The above embodiments admirably achieve the objects of the invention. However, it will be appreciated that departures can be made by those skilled in the art without departing from the scope of the invention which is limited only by the claims.

1-14. (canceled)

15. A method for a data transmission in a mobile communication system, wherein data is transmitted in data blocks from a transmitter to a plurality of receivers, said data blocks being identifiable by an identification, wherein the receivers send status indications to the transmitter whether a data block is correctly received, and wherein the transmitter is adapted to perform retransmissions according to the status indications, the method comprising the steps of:
providing the transmitter with a transmission window comprising the transmission status for the data blocks according to their identification;
performing a synchronization to the transmitter for a first receiver of said plurality of receivers by sending a synchronization message between the transmitter and the first receiver, the synchronization message being sent to at least two of said plurality of receivers, wherein a range of identifications of transmitted data blocks is selected in said synchronization;
the first and second receivers stops sending status indications for the data blocks corresponding to the selected range of identifications; and
the at least two of said plurality of receivers sending an acknowledgement for the synchronization message, wherein the transmitter deletes the transmission status indications corresponding to the selected range of identifications from the transmitter window after the acknowledgements are received from a predefined fraction of the plurality of receivers.

16. The method according to claim 15, wherein the synchronization message is sent from the transmitter to all receivers in said plurality.

17. The method according to claim 15, wherein the synchronization message is sent by the first receiver.

18. The method according to any claim 15, wherein synchronization events are defined for the transmitter and the first receiver and the synchronization is performed at the defined synchronization events.

19. The method according to claim 15, wherein the identifications of the data blocks are sequence numbers and the sequence numbers identify the data blocks in a modulo numbering scheme.

20. The method according to claim 15, wherein the receivers have a receiver window comprising identifications of data blocks, which are not correctly received, the receiver window having at least one edge, and wherein the edge of the receiver window is moved in the synchronization.

21. The method according to claim 15, wherein the transmission window comprises a cumulative transmission status for the identifications of the data blocks, wherein the cumulative transmission status is determined from the status indications sent by the receivers in said plurality.

22. The method according to claim 15, wherein the status indications from the receivers cumulatively acknowledge groups of correctly received data blocks.

23. The method according claim 15, wherein the receivers indicate the transmission status in a status message and the transmitter requests the status message with a poll message.

24. The method according to claim 23, wherein the receivers send the status message in reply to the poll message with a random delay.

25. The method according to claim 15, wherein a receiver joins or leaves the data transmission and the transmitter receives a notification of the joining or leaving.

26. The method according to claim 15, wherein the synchronization message identifies a valid selected range of identifications to a receiver joining the data transmission.

27. A transmitter for a mobile communication system, wherein the transmitter is adapted to transmit data blocks to a plurality of receivers, said data blocks being identifiable by an identification, and to receive status indications from the receivers whether a data block is correctly transmitted, and wherein the transmitter is provided with a transmission window comprising the transmission status for the data blocks according to their identification, the transmitter comprising:
means for performing a synchronization to the transmitter for a first receiver of said plurality of receivers by sending a synchronization message between the transmitter and the first receiver, the synchronization message being sent to at least two of said plurality of receivers, wherein a range of identifications of transmitted data blocks is selected in said synchronization;
means for stopping the transmission of status indications for the data blocks corresponding to the selected range of identifications; and
means for receiving an acknowledgement from the at least two of said plurality of receivers for the synchronization message, wherein the transmitter deletes the transmission status indications corresponding to the selected range of identifications from the transmitter window after the acknowledgements are received from a predefined fraction of said plurality of receivers.

28. A computer program product in a computer usable medium of a transmitter for a mobile communication system, wherein the transmitter is adapted to transmit data blocks to a plurality of receivers, said data blocks being identifiable by an identification, and said transmitter adapted to receive status indications from the receivers whether a data block is correctly transmitted, and wherein the transmitter is provided with a transmission window comprising the transmission status for the data blocks according to their identification, the computer program product comprising:
instructions within the computer usable medium for initiating a synchronization with a first receiver of said plurality of receivers by a synchronization message between the transmitter and the first receiver, and to send the synchronization message to at least a second receiver of said plurality of receivers, wherein the first and second receivers send an acknowledgement for the synchronization message;
instructions within the computer usable medium for selecting a range of identifications of transmitted data blocks in said synchronization, and
instructions within the computer usable medium for deleting the transmission status indications for the selected range of identifications from the transmitter window after the acknowledgements are received from a predefined fraction of the receivers, when executed in the processing unit.
